(19) United States
(12) Patent Application Publication
(10) Pub. No.: US 2024/0034360 A1
(43) Pub. Date: Feb. 1, 2024

(54) HANDLING FAULTS IN AUTONOMOUS VEHICLES

(71) Applicant: Truck OpCo LLC, Mount Pleasant, PA (US)

(72) Inventors: Albert Lorincz, LaGrange, KY (US); Matthew Daniel Cimino, Pittsburgh, PA (US); Mircea Florian Lupu, Pittsburgh, PA (US); Ralph A. Sprang, Pittsburgh, PA (US); Raymond Joseph Russell, Beaver, PA (US); Michael David George, Pittsburgh, PA (US); Venkataramanan Rajagopalan, Sewickley, PA (US); Cetin Alp Mericli, Pittsburgh, PA (US); Tekin Alp Mericli, Pittsburgh, PA (US); Alonzo James Kelly, Edgeworth, PA (US); Arunabh Sharma, Pittsburgh, PA (US)

(21) Appl. No.: 18/119,888

(22) Filed: Mar. 10, 2023

Related U.S. Application Data
(60) Provisional application No. 63/318,444, filed on Mar. 10, 2022.

(51) Int. Cl. B60W 60/00; B60W 50/02; B64U 80/86

(52) U.S. Cl. CPC B60W 60/0018; B60W 50/0205; B64U 80/86; B60W 2050/0215; B64U 2101/00

(57) ABSTRACT

An autonomous vehicle's control systems include an A-kit module that operates autonomy logic to generate a desired trajectory from sensor data. A B-kit module receives the desired trajectory and generates inputs for actuators such as steering, brake and throttle actuators based on the desired trajectory. Safing logic (which may be located in the A-kit, B-kit, both the A-kit and the B-kit or elsewhere within or outside of the vehicle) receives a sensor fault indication and executes a contingency trajectory such as a safing maneuver to bring the vehicle to a safe state.

### CROSS REFERENCE TO RELATED APPLICATION(S)

This application claims priority to co-pending U.S. Patent Application Ser. No. 63/318,444 filed Mar. 10, 2022 entitled “Handling Faults in Autonomous Vehicles”, the entire contents of which are hereby incorporated by reference.

### BACKGROUND

This patent application relates to fail-safe systems for autonomous vehicles, and more particularly to performing safing maneuvers such as to follow a safe trajectory upon detection of a fault.

Autonomous vehicles typically include a variety of cameras, lidars and other sensors to monitor nearby conditions such as the location of nearby objects such as lane markings, roadside objects and other vehicles. A controller includes autonomy logic to process data received from these sensors to determine inputs for throttle, brake and/or steering actuators that control operation of the vehicle.

However, these sensors may become impaired or even fail. Impairment or failure may be due to operating conditions, tampering, physical damage, component failure, lost connection, and for other reasons. The loss of one or more sensors may impede the autonomous vehicle's ability to operate properly.

### SUMMARY

What is needed is a way to safely control an autonomous vehicle when data from a sensor is lost or corrupted or otherwise reduced in quality.

In one embodiment, the vehicle's control systems include an A-kit module that operates autonomy logic to generate a desired trajectory from sensor data. A B-kit module receives the desired trajectory and generates inputs for actuators such as steering, brake and throttle actuators based on the desired trajectory. Safing logic (which may be located in the A-kit, B-kit, both the A-kit and the B-kit or elsewhere within or outside of the vehicle) receives a sensor fault indication and executes a safing maneuver to bring the vehicle to a safe state.

In some aspects, the techniques described herein relate to an apparatus or method for controlling an autonomous vehicle including: an A-kit module that receives sensor data and operates autonomy logic to generate a desired trajectory and a contingency trajectory that specifies a safing maneuver; a B-kit module that receives the desired trajectory, and generates corresponding inputs for steering, brake and/or throttle actuators of the vehicle based on the desired trajectory; and safing logic, configured to receive a sensor fault indication and the contingency trajectory, and configured to perform the safing maneuver to operate corresponding inputs for the steering, brake, and other throttle actuators to bring the vehicle to a safe state.

In some aspects, the A-kit sends the contingency trajectory to the B-kit module; and the B-kit module executes the safing logic to perform the contingency trajectory.

In some aspects, the B-kit module receives secondary sensor data and operates reduced level autonomy logic within the safing logic to perform the safing maneuver.

In some aspects, the secondary sensor data is received from an OEM sensor accessed via a Controller Area Network (CAN) bus on the vehicle.

In some aspects, the safing logic receives commands for the safing maneuver received from a companion vehicle via a wireless V2V link.

In some aspects, the commands are provided by autonomy logic in the companion vehicle.

In some aspects, the commands are provided by a human located in the companion vehicle.

In some aspects, the safing maneuver results in bringing the vehicle to a stop to a roadside or results in the vehicle following a companion vehicle.

In some aspects, a drone is activated upon the fault indication, to receive or generate drone sensor data and operate autonomy logic to generate a contingency trajectory, and to forward the contingency trajectory to the safing logic over a wireless link; and wherein the safing logic receives the contingency trajectory from the drone over the wireless link, and executes the contingency trajectory to perform the safing maneuver.

In some aspects, the contingency trajectory is generated on the B-kit module based on sensor data received from the drone.

In some aspects, the fault is a one or more of a sensor fault, autonomy logic fault, or interface fault that results in an inability to continuously generate desired trajectories within a certain time interval.

### BRIEF DESCRIPTION OF THE FIGURES

FIG. 1 is a block diagram of components of an autonomous vehicle.

FIG. 2 illustrates one scenario for handling faults.

FIG. 3 is an embodiment where a B-kit module receives information from secondary sensors.

FIG. 4 is an embodiment where the B-kit module receives commands for a safing maneuver from a companion vehicle.

FIG. 5 illustrates another embodiment where a drone is carried on the vehicle or a companion vehicle.

FIGS. 6A-6D illustrate a use case where detection of a fault on a follower vehicle causes a change in behavior of the lead vehicle.

FIGS. 7A to 7C are further examples of safing maneuvers.

FIGS. 8A to 8C are still other safing maneuvers.

### DETAILED DESCRIPTION

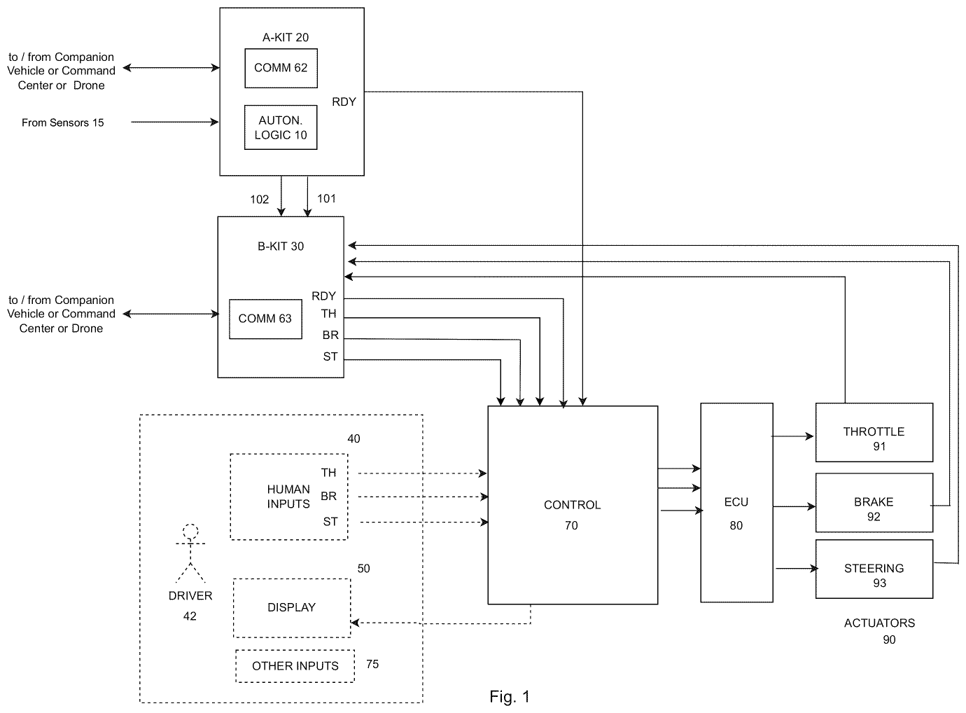

As shown more particularly in FIG. 1, a vehicle can be driven by either autonomy logic 10 or a human driver 42.

The human driver 42 provides inputs to the system controller 70 via typical human input devices 40 such as a throttle pedal (TH), brake pedal (BR) and steering wheel (ST). It should be understood that the reference to a “throttle” herein does not mean the vehicle must be driven by an internal combustion engine. The vehicle may be propelled by electric motors or other alternatives to fossil fuels.

The human driver 42 can also view a display 50 and operate other inputs 75.

The autonomy logic 10 receives inputs from sensors 15 such as one or more camera(s), lidar(s), radar(s), position sensor(s), and/or receive data from other sources via communication link(s) 62 and other inputs. The autonomy logic typically includes perception logic to determine that one or more current conditions are present from such sensor data, and then execute autonomous planner logic to generate one or more trajectories depending on those detected current conditions. The autonomy logic may be implemented such as the autonomy logic described in U.S. Patent Publication No. US2022/0198936A1 entitled “Shared Control for Vehicles Travelling in Formation” or as described in U.S. Patent Publication No. US20210129843A1 entitled “Behaviors That Reduce Demand on Autonomous Follower Vehicles” (each of which are hereby incorporated by reference) in or in many other ways.

The autonomy logic 10 produces autonomy control signals 101, 102 that may include a desired trajectory for the vehicle so that corresponding throttle, brake and steering signals can be generated by the controller 70.

The autonomy logic 10 may be part of an A-kit module 20.

The A-kit module 20 is responsible for generating instructions that describe a plan for the vehicle, such as a path that it should follow. The A-kit module also provides a ready signal RDY when the autonomy logic 10 determines that it has sufficient information to devise and approve of a trajectory for the vehicle to be autonomously driven. The A-kit 20 may also exchange data with a companion vehicle or a command center or an aerial drone via the communications 62 such as a Vehicle to Vehicle (V2V) link.

A B-kit module 30 receives inputs from the autonomy logic 10, such as instructions in the form of trajectories 101, 102 from the A-kit (including one or more trajectories to follow) and produces autonomy control signals 32 (for example including throttle (TH), brake (BR) and steering (ST) control signals) to the controller 70. The B-kit 30 may also exchange data with a companion vehicle or a command center or an aerial drone via a wireless interface 63 such as a V2V link. The B-kit 30 may also generate a ready (RDY) signal to report whether it is operating properly to the controller 70.

It should be understood that the A-kit 20 and B-kit 30 modules are preferably independent of one another. For example, a fault of the A-kit 20 electronics or control programming should be recoverable by the B-kit 30 to at least enable the vehicle to reach a safe state.

The controller 70 receives both human control inputs 40 from the human driver 42 and autonomous control inputs 32 (TH, BR, ST) from the B-kit module 30 and choses which set of control inputs to apply. The choice may make use of the RDY signals from the A-kit 20 and B-kit 30 to determine if those components are operating properly. The controller 70 feeds at least a selected one of the throttle control input to a Pulse Width Modulated (PWM) relay (not shown). The relay can select which of the inputs are fed to the vehicle's Electronic Control Unit (ECU) Steering and brake inputs may be controlled over a Controller Area Network (CAN) bus.

The ECU 80 in turn produces electronic control signals used by one or more actuators 90 which may include the vehicles throttle 91, brake 92 and steering 93 actuators that in turn operate the physical throttle, brake and steering sub-systems on the vehicle. In some implementations the ECU may not control one or more of the actuators, such as the steering 93.

The controller 70 may also receive inputs from actuators 90 that indicate their current status.

In some implementations the controller 70 may provide visual or audio alerts outputs to the output device(s) 50. The output device(s) may include indicator lights and/or a speaker and electronics that can playback pre-recorded audio messages to the human driver 42.

The controller 70 may also receive data from the human 42 such as via other input devices 75 such as a microphone or keyboard.

### Failure Handling Scenarios

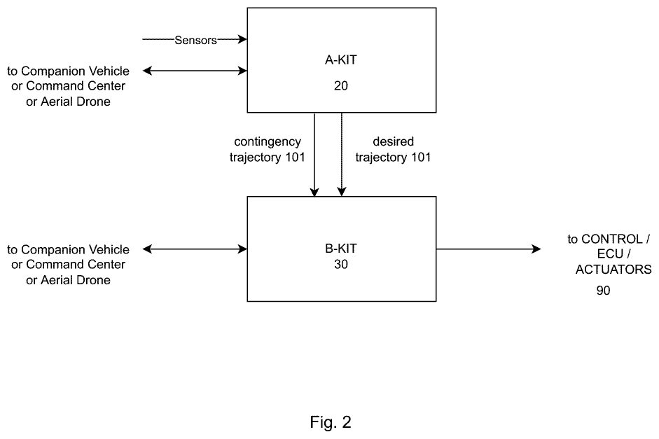

FIG. 2 illustrates one scenario for handling faults. Here the A-kit module 20 receives sensor data 15 and operates the autonomy logic 10 to continuously generate a desired trajectory 101 that is to be executed in a normal state of the vehicle, such as when no faults are present. The desired trajectory 101 is then continuously sent to the B-kit 30. The desired trajectory 101 may continuously change based on the current status of the vehicle. For example, the desired trajectory may change based on a desired route, or the presence of objects in the vicinity of the vehicle such as road markings, roadside objects, and other vehicles, as well as traffic conditions, weather, ambient conditions, and the like.

The B-kit module 30 receives the desired trajectory 101 and generates “maneuvers” in the form of inputs to the steering, brake and or throttle actuators 90 based on the desired trajectory 101. In some instances, the autonomy control signals 32 may pass from the B-kit to the controller 70 and/or directly to the ECU 80 before resulting in control signals being input to the actuators 90.

Here, the A-kit 20 may also be responsible for detecting one or more fault conditions. Such faults may include a failure detected by one of the sensors 15 or in one or more of the sensors 15 itself. However these faults may be detected in other components such as in the autonomy logic 10 itself, or in other processors, or in other components of the A-kit 20.

In some environments, the A-kit module 20 also continuously sends one or more contingency trajectories 102 to the B-kit 30. The contingency trajectory(ies) 102 are typically also continuously generated by governing logic or other parts of the autonomy logic 10 based on current conditions. A given contingency trajectory 102 is executed by the B-kit module to perform a safing maneuver in response to a particular fault or faults.

The safing maneuver, as specified by a contingency trajectory, may include stopping the vehicle, pulling to the side of the road, taking an exit, changing the vehicle's speed, or changing position with respect to another vehicle, or other some other maneuver that places the vehicle in a known safe state.

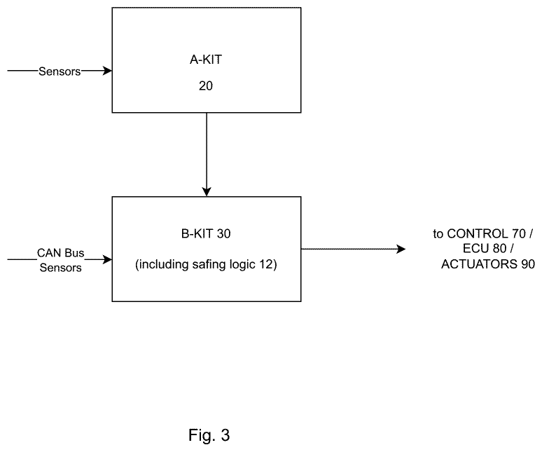

FIG. 3 is another environment where in addition to receiving the trajectories 101 and 102 from the A-kit 20, the B-kit 30 also directly receives information from secondary sensors 105. These secondary sensors may include OEM sensors accessible via the vehicle's Controller Area Network (CAN) bus. The B-kit module 30 may use these additional sensor input(s) 105 to further determine how or when to execute either the normal desired trajectory 101 or the contingency trajectory 102.

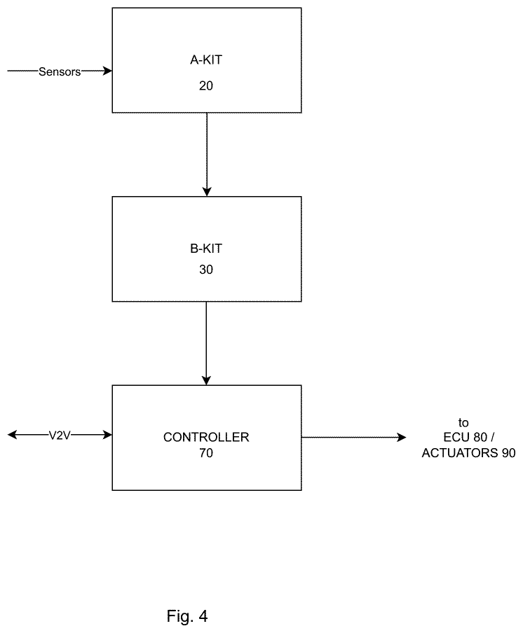

In another scenario depicted in FIG. 4, the B-kit module 30 may receive a contingency trajectory 102 (or some other instructions that constitute a safing maneuver) from a companion vehicle such as via its V2V link 63. The B-kit module may also include an additional controller 72 that is dedicated to processing such contingency trajectories such as when the autonomy logic 10 has failed or to process contingency trajectories received from the companion vehicle.

In yet another scenario, the safing maneuver 102 may be provided by a human located in a companion vehicle. For example, braking, throttle and steering inputs may be provided over the V2V link to directly control the vehicle's actuators in an emergency situation.

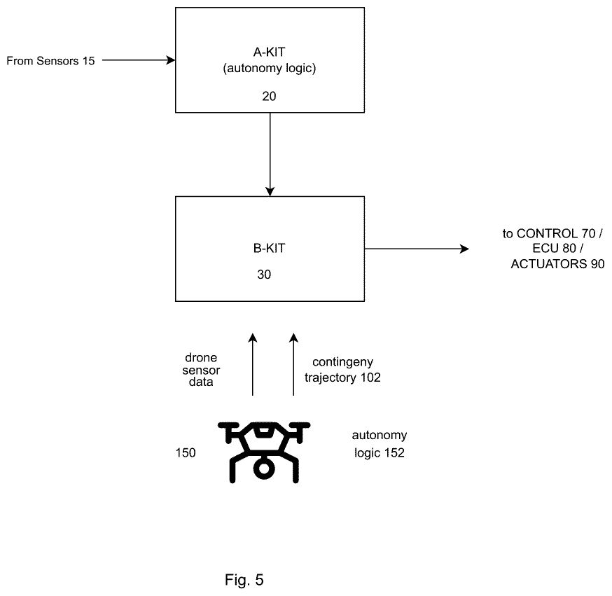

FIG. 5 illustrates another embodiment where a drone 150 is carried on the vehicle or on a companion vehicle to assist with generating the contingency trajectory and/or executing a safing maneuver. The drone 150 is activated upon detection of a fault and may be programmed to hover near the vehicle with the fault. The drone 150 may carry sensors 154 to generate its own sensor data or it may receive sensor data from a companion vehicle. It may forward such sensor data to the A-kit for processing by autonomy logic 1

In some aspects, the techniques described herein relate to an apparatus for controlling an autonomous vehicle including: an A-kit module that receives sensor data and operates autonomy logic to generate a desired trajectory and a contingency trajectory that specifies a safing maneuver; a B-kit module that receives the desired trajectory, and generates corresponding inputs for steering, brake and/or throttle actuators of the vehicle based on the desired trajectory; and safing logic, configured to receive a sensor fault indication and the contingency trajectory, and configured to perform the safing maneuver to operate corresponding inputs for the steering, brake, and other throttle actuators to bring the vehicle to a safe state.

In some aspects, the techniques described herein relate to an apparatus wherein: the A-kit sends the contingency trajectory to the B-kit module; and the B-kit module executes the safing logic to perform the contingency trajectory.

In some aspects, the techniques described herein relate to an apparatus wherein: the B-kit module receives secondary sensor data and operates reduced level autonomy logic within the safing logic to perform the safing maneuver.

In some aspects, the techniques described herein relate to an apparatus wherein the secondary sensor data is received from an OEM sensor accessed via a Controller Area Network (CAN) bus on the vehicle.

In some aspects, the techniques described herein relate to an apparatus wherein: the safing logic receives commands for the safing maneuver received from a companion vehicle via a wireless V2V link.

In some aspects, the techniques described herein relate to an apparatus wherein: the commands are provided by autonomy logic in the companion vehicle.

In some aspects, the techniques described herein relate to an apparatus wherein the commands are provided by a human located in the companion vehicle.

In some aspects, the techniques described herein relate to an apparatus wherein the safing maneuver results in bringing the vehicle to a stop to a roadside or results in the vehicle following a companion vehicle.

In some aspects, the techniques described herein relate to an apparatus additionally including: a drone, initially carried on the vehicle or a companion vehicle and activated upon the fault indication, to receive drone sensor data and operate autonomy logic to generate a contingency trajectory, and to forward the contingency trajectory to the safing logic over a wireless link; and wherein the safing logic receives the contingency trajectory from the drone over the wireless link, and executes the contingency trajectory to perform the safing maneuver.

In some aspects, the techniques described herein relate to an apparatus wherein the contingency trajectory is generated on the B-kit module based on sensor data received from the drone.

In some aspects, the techniques described herein relate to an apparatus wherein the fault is a one or more of a sensor fault, autonomy logic fault, or interface fault that results in an inability to continuously generate desired trajectories within a certain time interval.0 to further assist with generating the contingency trajectory 102.

In some embodiments, the drone 150 may itself include autonomy logic 152. The autonomy logic 152 in drone 150 may generate the contingency trajectory 102 and forward it to the B-kit 30 such as over wireless link 63. The B-kit module 30 may receive this contingency trajectory 102 from the drone and execute the resulting safing maneuver(s).

The contingency trajectory(ies) may also involve generating safing maneuvers for a companion vehicle. For example, a fault may occur in only one of a pair of vehicles travelling in a convoy. However the contingency trajectory should involve generating safing maneuvers so that both vehicles reach a safe stage.

The following Table lists some examples of safing maneuvers, the corresponding system functions and a description of each.

| Safing Maneuver | Function(s) | Description |
|---|---|---|
| Take vehicle to the | A-Kit continuously | B-Kit implements trajectory in case of a |
| shoulder: an A-Kit | transmits a contingency | failure (such as a vision sensor or |
| centric approach | trajectory to the B-Kit | perception logic failure |
| | | A-Kit predicts where objects and other |
| | | vehicles will be present within the next 30 |
| | | seconds |
| | | A-Kit also generates a contingency |
| | | trajectory that controls a companion |
| | | vehicle to allow for the maneuver to be |
| | | feasible (i.e. both slow down and stay in |
| | | the right lane unless passing another |
| | | vehicle) |
| Driver takes control: | B-Kit alerts the driver to | B-Kit requires access to a minimum set |
| B-Kit temporarily | take over control while | of sensors to implement its own follow the |
| takes over control of | continuing to follow | leader autonomy logic |
| a “follower the | another vehicle in front | Another solution is receive the follow the |
| leader” trajectory and | (not necessarily the | leader autonomy safing maneuver via the |
| alerts the driver to | leader vehicle) | communications link from another |
| take control of the | | vehicle.. |
| vehicle | | An assumption may be that the driver |
| | | will take control of the vehicle, e.g. within |
| | | 1 minute from detection of the fault, or else |
| | | some other contingency trajectory is |
| | | followed. |
| Take vehicle to the | B-Kit monitors | B-Kit needs access to a minimum set of |
| shoulder: a B-Kit | conditions to determine | sensors to monitor its environment (e.g., |
| centric approach | when it is safe to move | lidars on each side to detect vehicles in |
| | vehicle to the shoulder | adjacent lanes/shoulder) |
| | and brings it to a | B-Kit generates and implement |
| | complete stop | contingency trajectory to implement the |
| | | move to the shoulder. |
| Take vehicle to the | A drone is deployed | Drone has: |
| shoulder: drone | when a fault such as in | capabilities to transmit contingency |
| approach | the perception | trajectories to the B-Kit (robust |
| | capabilities of the | communication link) |
| | autonomy logic are lost. | perception capabilities to recognize |
| | Drone takes over | traffic around vehicle (e.g., a sensor such |
| | perception | as a camera and perception logic) |
| | responsibilities and | localization (GPS) capabilities |
| | guides the vehicle to the | drone should be capable of rapid |
| | shoulder or bring to a | deployment |
| | safe stop. | |
| Leader driver take | V2V communications | Enables when both A-kit and B-kit |
| convoy to shoulder | link provides connection | autonomy logic have failed. |
| | to permit remote control | |
| | of actuators | |

### Use Cases for Vehicles Travelling in Formation

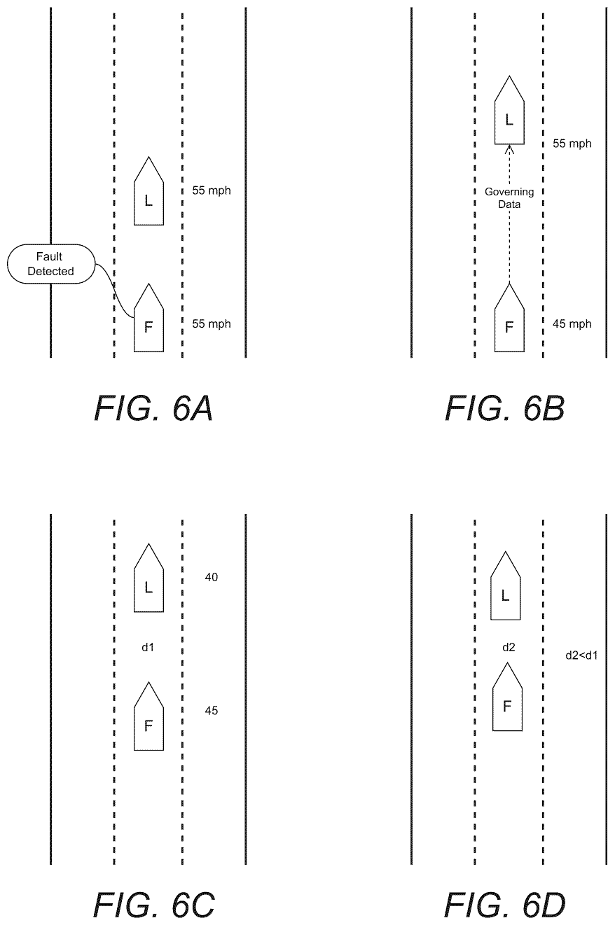

FIGS. 6A-6D illustrate a use case for the system 100 described above. Here two vehicles are travelling in a formation such as convoy. The detection of a fault on a follower vehicle F (such as by the A-kit 20) causes a change in the trajectory, e.g., a change in behavior, of another vehicle such as a lead vehicle L. As shown in FIG. 6A, a convoy or other vehicle formation is composed of a lead vehicle L and a follower vehicle F. At this point the convoy is operating normally with each vehicle traveling at a speed of 55 miles per hour. In this example, the follower F is a robotic vehicle controlled by autonomy logic 10 that is programmed to follow a human driven leader vehicle L.

At some point as shown in FIG. 6B a fault is detected in the follower F. The follower then executes a safing maneuver to slow down, such as by the A-kit 20 generating a contingency trajectory 102 that is then executed by the B-kit 30. However the leader L is not yet aware of the fault condition and so therefore continues at 55 mph for a short time. Eventually the leader L is informed of the fault, either by using its own sensors to detected the slowing follower F, or by the follower F sending a message to leader L in the form of governing data sent over a wireless link 62 or 63.

In FIG. 6C the governing data sent over a wireless link 62 or 63 causes leader L to also slow and also possibly to reduce or increase a space between the vehicles. In FIG. 6D both leader L and follower F are now traveling at the lower speed with a space between them that depends on the fault condition.

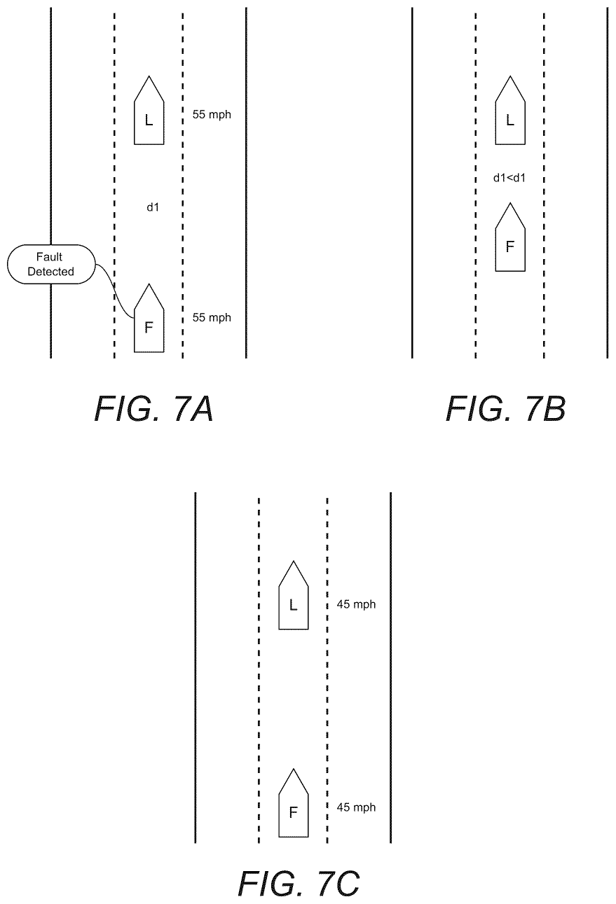

FIGS. 7A to 7C are further examples of safing maneuvers. In an initial state shown in FIG. 7A, the leader L and follower F are traveling at 55 mph; the follower has detected a fault. In the state shown in FIG. 7B a space between vehicles is modulated such that the follower now travels closer to or further from the leader.

FIG. 7C is another example of a response to a fault, where the safing maneuver causes the vehicles to now travel at a slower speed for example, at 45 mph.

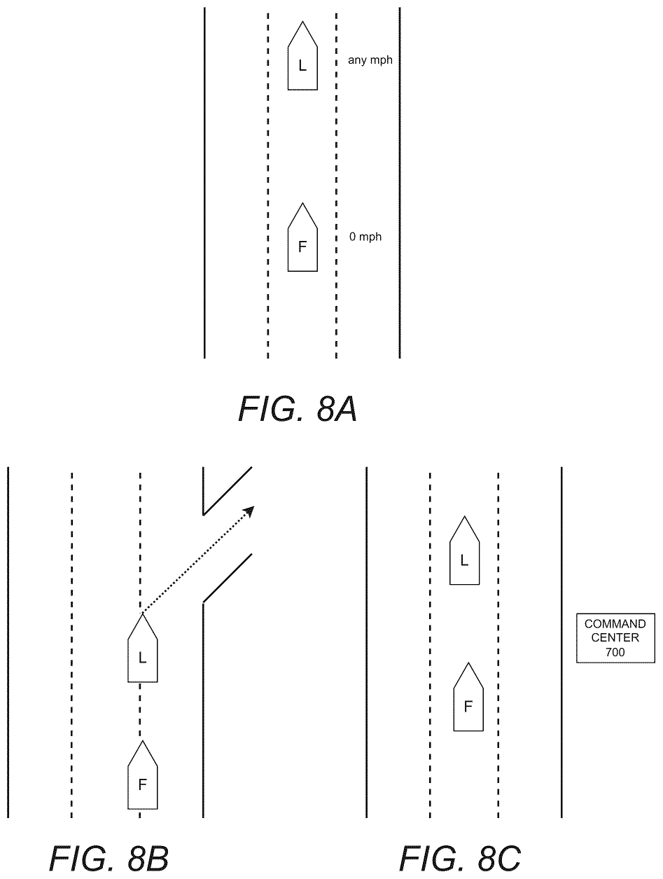

FIG. 8A is an example where the follower F has stopped in its lane as a result of executing the safing maneuver. The leader L carries on its journey.

FIG. 8B is an example where the fault is detected by a follower F and reported to leader L and the safing maneuver is for both vehicles to take a nearby exit.

FIG. 8C is an example where after the fault, the follower F is being controlled by commands received wirelessly over link 62 or 63 from a command center 700 instead of using its own autonomy logic 10. The command center may operate its own autonomy logic or may be human-controlled. It may be possible for vision sensors (cameras or lidars) on the follower F to be transmitted to the command center 700 over the wireless link 62 or 63. In another instance where there is a failure of a vision sensor on a follower F, a vision sensor on a companion vehicle such the leader L or the drone 150 may be forwarded to the command center to assist with controlling the follower F.

### Other Scenarios

Autonomy logic on the vehicle with the failed sensor may suggest or restrict the motions of a companion vehicle. In one example, after detecting a fault, a follower vehicle F may request that the companion vehicle L to speed up if the failure relates to a condition where the follower vehicle F may not be able to stop quickly or safely. In another example, the part of the autonomy logic responsible for contingency planning in a follower vehicle F may instruct autonomy logic in a leader vehicle L to slow down or speed up as soon as possible— well before a human driver in the lead vehicle would notice or react to the fault.

In addition, “safing data” may include something other than a trajectory, such as where the B kit has sufficient intelligence to process safing data to derive a safing maneuver on its own. In one example, the safing data could simply include positions and speeds of all nearby traffic.

The drone sensor data (e.g., the “safing data”) may be replaced or augmented by VtoV data received from third party vehicles or from Vehicle-to-Infrastructure (VTI) data available from transportation infrastructure.

Safing data may also originate from companion vehicle. In one example, this can be a video feed from a rear facing camera on the leader which is forwarded to failed follower over a V2V link.

The failure detection logic may be located in any or all of the A-Kit (A), B-Kit(B), Controller (C), or ECU (E), or a human (H). Thus generally speaking, the contingency trajectory may also be located in or generated by any of the A-kit 20, B-kit 30, Controller 70, ECU 80, or human 42.

A “command” executed in response to a fault may include generating governing data. Autonomy logic responsible for carrying out the safing maneuver may also exist in any of the A-kit 20, B-kit 30, Controller 70, ECU 80, or human 42 in the companion vehicle.

The safing action may be generated in many places including the vehicle with the failure, a companion vehicle, or a flying drone, or a command center. In any of these cases, autonomy logic or a human being may be the source that initiates the safing maneuver.

A safing action may simply be the execution of a contingency action. However the safing action may comprise a stream of other data that comes from anywhere such as teleoperation from command center, another vehicle, or a drone.

A sequence of events may be as follows:

1. Contingency actions are generated continuously such as by autonomy logic in an A-kit.

2. Fault detection logic in the A-kit detects a fault. Notification of this event is broadcast such as to the B-kit in the same vehicle or a companion vehicle.

3. Fault response logic receives the broadcast notification, decides on and initiates a contingency trajectory as a response.

4. The response may include multiple actions in multiple places. For example, the response may reconfigure assets (such as to launch a drone), or activate a control device (such as a joystick on a leader), transfer or modify control (such as via contingency autonomy commands) and/or data streams (such as generating video from a drone).

5. The response may play out over an extended period of time—such as at least the time it takes to move a follower F off of the road to a safe location, such as onto a shoulder, or to the next exit ramp, for example.

### Further Implementation Options

It should be understood that the example embodiments described above may be implemented in many different ways. In some instances, the various “data processors” and / or “logic” may be implemented by a physical or virtual general purpose computer apparatus having a central processor, memory, disk or other mass storage, communication interface(s), input/output (I/O) device(s), and other peripherals. The general-purpose computer is transformed into the processors and executes the processes and methods described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. An apparatus for controlling an autonomous vehicle comprising:
an A-kit module that receives sensor data and operates autonomy logic to generate a desired trajectory and a contingency trajectory that specifies a safing maneuver;
a B-kit module that receives the desired trajectory, and generates corresponding inputs for steering, brake and/or throttle actuators of the vehicle based on the desired trajectory; and
safing logic, configured to receive a sensor fault indication and the contingency trajectory, and configured to perform the safing maneuver to operate corresponding inputs for the steering, brake, and other throttle actuators to bring the vehicle to a safe state.

2. The apparatus of claim 1 wherein:
the A-kit sends the contingency trajectory to the B-kit module; and
the B-kit module executes the safing logic to perform the contingency trajectory.

3. The apparatus of claim 1 wherein:
the B-kit module receives secondary sensor data and operates reduced level autonomy logic within the safing logic to perform the safing maneuver.

4. The apparatus of claim 3 wherein the secondary sensor data is received from an OEM sensor accessed via a Controller Area Network (CAN) bus on the vehicle.

5. The apparatus of claim 1 wherein:
the safing logic receives commands for the safing maneuver received from a companion vehicle via a wireless V2V link.

6. The apparatus of claim 5 wherein:
the commands are provided by autonomy logic in the companion vehicle.

7. The apparatus of claim 5 wherein the commands are provided by a human located in the companion vehicle.

8. The apparatus of claim 1 wherein the safing maneuver results in bringing the vehicle to a stop to a roadside or results in the vehicle following a companion vehicle.

9. The apparatus of claim 1 additionally comprising:
a drone, initially carried on the vehicle or a companion vehicle and activated upon the fault indication, to receive drone sensor data and operate autonomy logic to generate a contingency trajectory, and to forward the contingency trajectory to the safing logic over a wireless link; and
wherein the safing logic receives the contingency trajectory from the drone over the wireless link, and executes the contingency trajectory to perform the safing maneuver.

10. The apparatus of claim 9 wherein the contingency trajectory is generated on the B-kit module based on sensor data received from the drone.

11. The apparatus of claim 1 wherein the fault is a one or more of a sensor fault, autonomy logic fault, or interface fault that results in an inability to continuously generate desired trajectories within a certain time interval.
